(19) United States
(12) Patent Application Publication
(10) Pub. No.: US 2020/0129986 A1
(43) Pub. Date: Apr. 30, 2020

(54) Device for Separating Conglomerates that Consist of Materials of Different Densities

(71) Applicants: Claus GRONHOLZ, Ammersbek (DE); TARTECH ECO INDUSTRIES AG, Oberursel (DE)

(72) Inventor: Claus Gronholz, Ahausen/Eversen (DE)

(21) Appl. No.: 16/618,856

(22) PCT Filed: Jun. 4, 2017
(86) PCT No.: PCT/EP2017/063594

§ 371 Date: Dec. 3, 2019

(51) Int. Cl. B02C 13/16; B02C 13/282; B02C 13/30

(52) U.S. Cl. CPC B02C 13/16; B02C 2013/2808; B02C 13/30; B02C 13/282

(57) ABSTRACT

A device for separating conglomerates that consist of materials of different densities is provided. The device has a rotor chamber in which a rotor shaft is mounted so as to be rotatable about a vertical axis, on which rotor shaft striking tools are arranged one beneath the other in at least two planes, which striking tools are set into rotational movement by the rotor shaft such that the conglomerates filled into the rotor chamber from above are captured and separated by the striking tools. The rotor chamber widens conically downward, and the outer radius of the striking tools increase from top to bottom, such that the spacing of the radially outer end edges of the striking tools from the chamber wall facing the striking tools is substantially the same in the individual planes during operation.

The invention relates to a device for separating conglomerates that consist of materials of different densities, having a rotor chamber in which a rotor shaft is mounted so as to be rotatable about a vertical axis, on which rotor shaft striking tools are arranged one beneath the other in at least two planes, which striking tools are set into rotational movement by the rotor shaft such that the conglomerates filled into the rotor chamber from above are captured and separated by the striking tools.

During metal processing or other manufacturing and processing procedures there is an accumulation of slag, which contains metal components. However these are often present in scaled form or are embedded in mineral components. It is therefore usual to break up such slag mechanically to enable separation of the metallic components from the mineral or non-metallic components in a further processing step.

From WO 2012/171597 it is known that slag of this sort can be crushed in an impact mill. The conglomerates hit the striking tools which are rotating at high speed. The impact causes the lighter mineral components to separate from the heavier metallic components. The arrangement is such that the striking tools in the vertically aligned impact chamber are arranged one beneath the other in several planes and that the lower positioned striking tools rotate at a higher speed than the higher positioned striking tools.

Furthermore the vertically aligned impact chamber comprise a substantially cylindrical form, while the diameter of the rotor shaft increases from top to bottom. Therefore the rotor chamber becomes narrower from top to bottom and is shifted outwards. In this way the already crushed or smaller conglomerates reach an outer zone where the striking tools have a higher speed. Thus it is ensured that these conglomerates are also crushed.

Good results can be achieved with this device. However the construction of the rotor shaft is relatively complex, as this consists of several hollow shafts so that the different rotational speeds are adjustable in the different planes. Also the conglomerates spend a relatively short time in the device so that separation remains incomplete.

It is an object of the invention to design a device as described above which avoids these disadvantages.

According to the invention the object is solved by having the rotor chamber widen conically downward, and having the outer radius of the striking tools increase from top to bottom such that the spacing of the radially outer end edges of the striking tools from the chamber wall facing said striking tools is substantially the same in the individual planes during operation.

The rotor chamber widens continuously and with a substantially smooth inner surface conically from top to bottom. The length of the striking tools in the individual planes is calculated such that in the operating position there is substantially the same spacing between the radially outer end edge of the striking tools and the inner surface of the rotor chamber.

Preferably the inner surface of the rotor chamber in the zone of the planes with the striking tools runs in a straight line, so that when viewed in mid-longitudinal section, the rotor chamber has the shape of a symmetrical and equal-sided trapezoid. The inner surface of the rotor chamber can also run in a constant curve which widens towards the bottom. This makes the rotor chamber bell-shaped when viewed in mid-longitudinal section. In this way the same effect is achieved as with a straight-running inner surface of the rotor chamber.

This design achieves an increase in the rotational speed of the striking tools in the lower planes. The rotor zone also increases from top to bottom, so that the slag lumps/conglomerates in the lower planes will in all probability be captured several times by the striking tools and on their route through the rotor chamber from top to bottom with higher impact speed. This allows better breaking-up of the conglomerates.

During this process the metal component will not be crushed, for example because no grinding process takes place. The metal components are only blasted from the mineral components, as these, compared to the same size of metal components, have a smaller mass and therefore less kinetic energy or inertia, so that the heavier metallic components experience a different acceleration force as the result of the impact. Therewith the brittle encasement is blasted off. In a further processing step the metallic components can be separated from the mineral components using conventional separating devices such as gravity separators, magnetic separators or eddy current separators.

The striking tools can be mounted rigidly on the rotor shaft. However it is advantageous if the striking tools are mounted flexibly on the rotor shaft so that they can pivot with the rotation into a horizontal position. Due to the high rotational speed it is favourable if the striking tools of a plane are arranged in axial symmetry to the rotation axis. With that unbalances are avoided.

The slag is continuously filled via an upper hopper into the rotor chamber. There is therefore also a cover provided above the highest plane, which cover extends in radial direction at least partly over the linkage of the striking tools on the rotor shaft. The cover surface widens in a downward direction so that the slag is conducted onto the striking tools rotating below. On the one hand this avoids the slag reaching the discharge point below in the region of the rotor shaft without being crushed. On the other hand it prevents the slag lumps from landing on the linkage of the striking tools, which could otherwise wear more quickly.

Thus it is ensured that the slag lumps are captured and crushed by the striking tools. The crushed pieces bounce off the striking tools and hit the chamber wall, from which they rebound back into the rotation chamber. They are then either captured by the rotating striking tools in the same plane or another, in particular lower, one, and are crushed further. Due to the higher peripheral speed of the striking tools in the lower planes because of their greater diameter, tenacious caking of mineral slag can be reliably blasted off the metal components.

Furthermore it is advantageous to have deflector plates between the striking tools in a plane, which are fixed to and extend radially from the rotor shaft. The deflector plate prevents the impacting of slag lumps from the chamber wall on the rotor shaft, ensuring a good protection of the shaft against damage and wear. In particular the arrangement can be such that the striking tools in a plane are fixed to a flange and that the deflector plates are shaped as a part of a ring with their inner edges fixed to the flange. The radial outer edge of the deflector plates can extend over the linkages of the striking tools on the rotor shaft.

According to a further embodiment of the invention provision is made that at least the upper section of the rotor shaft be constructed as a hollow shaft, on which there is at least one upper plane is arranged with striking tools and which incorporates at least one concentrically running shaft, on which there is arranged at least one lower plane with striking tools. In this way it is possible to adjust the rotational speeds and the direction of rotation of the lower planes independently from those of the upper planes.

Provision can be made that the striking tools in a lower plane are driven at a different and in particular higher speed in the same or opposite direction of rotation as for those in a higher plane. In particular a change in the direction of rotation can achieve double the relative speed of the striking tools positioned one beneath the other.

Breaking up of the conglomerates is ensured, and an effective separation of the metallic and non-metallic components is possible.

Hereby provision can be made that the rotational speed of the striking tools in an upper plane be 500 rpm up to 1200 rpm. The rotational speed of the striking tools in a lower plane can be 600 rpm up to 1300 rpm. The effective outside diameter of the striking tools can be between 1.0 m and 3.0 m. At this speed the kinetic energy of the components of a conglomerate differs so much that blasting open of the lump is ensured.

Provision can be made that the cone angle applied from the chamber wall be 20° up to 50° and particularly 24° up to 30°. This ensures that the particles rebounding off the striking tools are conducted back into the rotor chamber. In operating position the front edges of the striking tools run preferably at an angle of 2° up to 15° in relation to the vertical. Thus the blasted particles hit the chamber wall in such a way that they mostly remain in the same plane of striking tools. The amount of time that the slag spends in the device is thus raised and the probability that a slag lump will rebound and shatter is increased.

This principle of shattering assumes, among other things, that the slag lumps will rebound from the chamber wall back into the rotor zone in a defined manner. However, due to its moisture content of 5.0 M-% up to 20.0 M-% (M-%=percent by mass), the slag to be processed has the capacity to adhere to walls or the like and form encrustations. It is therefore advantageous to have at least one knocking tool on the outside chamber wall. Regular knocking causes the chamber wall to vibrate so that adhesions or encrustations are released and the chamber wall retains the desired rebounding properties.

Hereby provision can be made for several, for example five or six, knocking tools along the circumference of the rotor chamber which preferably are activated consecutively. In this way the chamber wall can be vibrated at short intervals, whereby each initial point of vibration is different. In this way the internal chamber wall is efficiently cleared of caking. It is also advantageous if the knocking tools are active during operation. In this way the encrustations which are released from the inner walls in the form of sheets or slabs are captured by the rotating striking tools and crushed again. This is favourable for the subsequent re-processing. Provision can be made for example that with five striking tools along the perimeter of the rotor chamber a striking tool sets off a vibration every 30 to 90 seconds. Then after 150 to 450 seconds all the striking tools will have been active once, ensuring the release of encrustations on the inner chamber wall. Thus the rebound behaviour of the chamber wall necessary for correct operation is maintained.

Furthermore it is advantageous if the rotor chamber is mounted flexibly on vibration absorbers in the device structure. Thereby the vibrations caused by the knocking tools are absorbed and will not transfer to the other machine parts, particularly not to the bearings of the rotor shafts. In this way the rotor shaft and therefore the striking tools fixed to it are disconnected from the rotor chamber and its walls. The rotor shaft extends from above into the rotor chamber and because of the vibration absorbers it has no direct mechanical connection with the rotor walls. Thus the vibrations applied to these have no effect on the shaft bearings, which are already under heavy strain from the high rotational speeds. The service life of the device is thus increased.

The invention is explained more fully below using the schematic drawings. The following are shown:

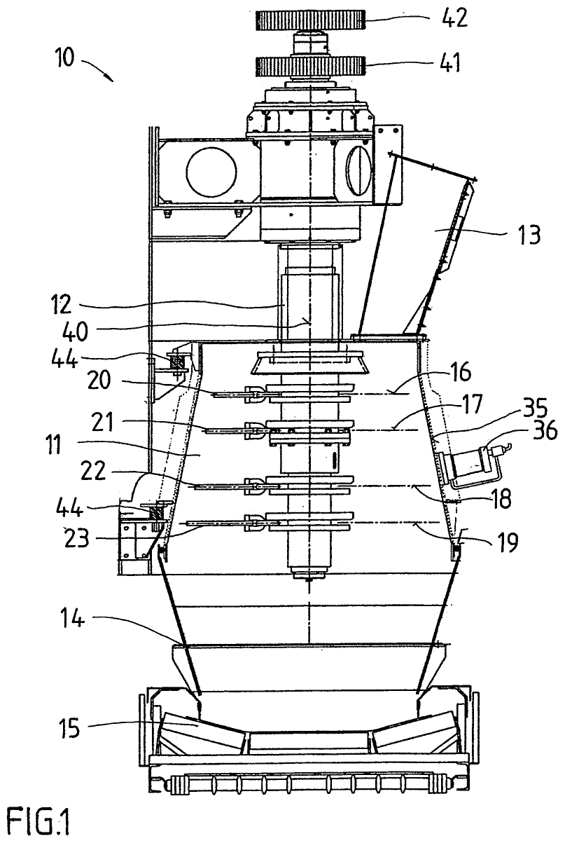

FIG. 1 a longitudinal section of the device according to the invention,

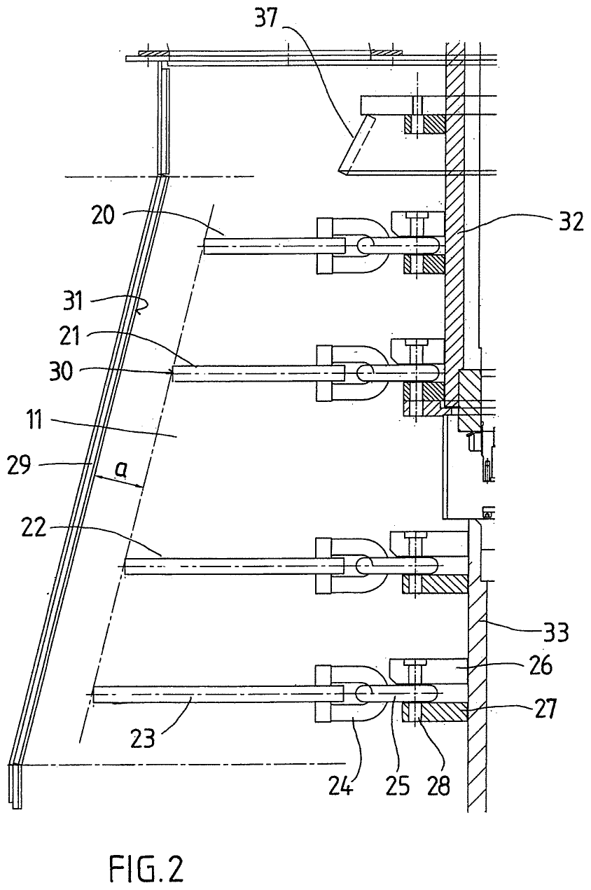

FIG. 2 an enlarged view of the rotor chamber,

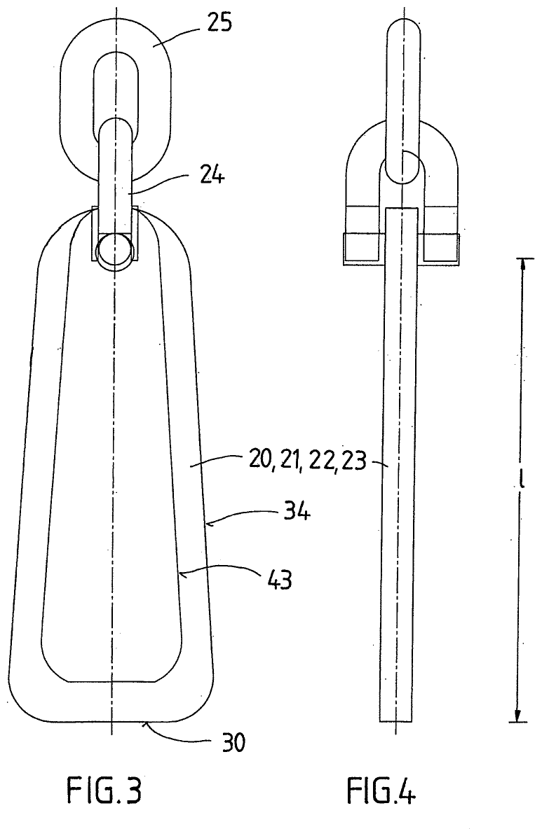

FIG. 3 a top view of a striking tool,

FIG. 4 a side view of the striking tool as in FIG. 3,

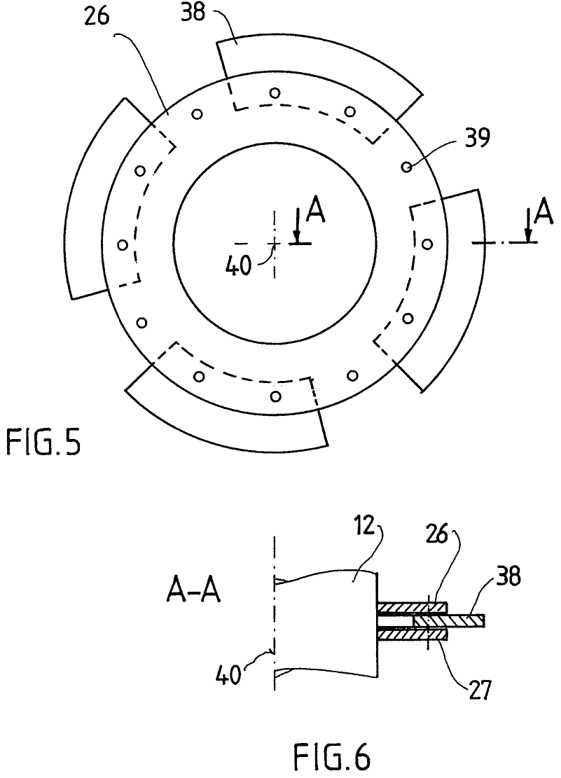

FIG. 5 a top view of one plane of striking tools and

FIG. 6 the sectional view A-A as in FIG. 5

The device 10 shown in the drawing for blasting slag lumps comprises a rotor chamber 11, in which a vertical rotor shaft 12 is mounted so as to be rotatable about a vertical axis 40. The interior of the rotor chamber 11 in cross-section has a circular form and the rotor shaft 11 runs concentrically thereto. In the upper part of the rotor chamber 11 there is a feed-hopper 13, through which the bulk material to be separated can be filled into the rotor chamber 11. At the lower end of the rotor chamber 11 there is a collection-hopper, through which the crushed product is collected and discharged by a discharge unit 15 which is not further specified.

On the rotor shaft 12 striking tools 20, 21, 22, 23 are arranged in several planes 16, 17, 18, 19. Specifically the arrangement is such that each striking tool 20, 21, 22, 23 is held by two chain links 24, 25 between two circumferential flanges 26, 27 with a pin 28. Thus the striking tool 20, 21, 22, 23 is pivotably attached to the rotor shaft 12 not only about a horizontal but also about a vertical axis. When the rotor shaft 12 is stationary the striking tools 20, 21, 22, 23 hang down from the suspension mount formed by the chain links 24, 25. As soon as the rotor shaft 12 rotates, the striking tools are raised into the horizontal operating position. The dimensions are calculated such that in the horizontal operating position a space “a” remains between the radial outer end walls 30 of the striking tools 20, 21, 22, 23 and the inner wall 31 of the rotor chamber. This ensures that the rotor shaft is able to rotate freely and that there is a high probability that the slag lumps poured in will be captured by the striking tools.

In the operating position with the rotor shaft 12 rotating, the material to be crushed is filled into the rotor chamber 11 and lands in the capture range of the fast rotating striking tools 20, 21, 22, 23. The individual lumps are hit by the striking tools and the heavy impact causes the lumps to shatter. Particularly in the case of conglomerates with metallic and non-metallic components it causes the non-metallic components to break off and separate from the metallic components.

The resulting mix of separated metallic and non-metallic components lands in the collection-hopper 14 and from here is led to further processing, and particularly to the actual separation of metallic slag from non-metallic slag.

In this respect the separation of slag lumps in an impact mill is generally known and therefore requires no further explanation.

In the embodiment shown in the drawing the rotor chamber 11 extends conically from top to bottom. Thus the rotor chamber 11 has the form of a circular truncated cone in cross-section with smooth walls and no ledge.

The striking tools 20, 21, 22, 23 are fitted according to the gradient of the chamber wall 29 and therefore increase in length from top to bottom. The rotor shaft has substantially the same diameter along its entire length. Hereby provision is made that the spacing “a” of the outer end edge 30 of a striking tool 20, 21, 22, 23 to the inner wall 31 of the rotor chamber 11 be substantially the same in each plane 16, 17, 18, 19. Thus the effective length “1” of a striking tool 20, 21, 22, 23 increases from top to bottom. Overall it is achieved with this arrangement that smaller lumps are also captured and broken up.

Due to the greater diameter of the striking tools in the lower section of the rotor chamber 11, the peripheral speed of the lower striking tools 22, 23 on their outer areas is higher than that of the upper striking tools 20, 21, when the upper section of the shaft and the lower section of the shaft 33 have the same rotational speed. The higher speed enables also smaller lumps to be crushed and the embedded metallic component to be separated.

In order to achieve an even higher impact speed of the slag lumps onto the striking tools 20, 21, 22, 23 the rotor shaft 12 is formed of two parts. The upper section 32 is designed as a hollow shaft, in which the lower, concentrically rotatable, section 33 is positioned. The upper shaft section 32 carries the two upper planes 16, 17 with the striking tools 20, 21, whilst the lower shaft section 33 carries the striking tools 22, 23 of the lower planes 18, 19. Both shaft sections 32, 33 can be driven by separate drives 41, 42 at different speeds in a different or in the same direction of rotation. In particular it is provided that the lower shaft section 33 is driven at a higher speed than the upper shaft section. Furthermore it is preferable that the lower shaft section 33 rotates in the opposite direction to the upper shaft section 32.

In this way the impact speed at which the lumps hit the counter-rotating lower striking tools 22, 23 is considerably increased. The lumps are at first accelerated by the upper striking tools 20, 21 in one direction. In the upper planes 16, 17 the larger lumps are crushed. These lumps are thrown against the rotor chamber wall 29 and rebound off this onto the striking tools in the same plane or another plane. The broken lumps then land in the zone of the lower planes 18, 19, in which they are captured by the counter-rotating striking tools 22, 23 and crushed further.

Provision can here be made that the tangential and/or radial front edges 30, 34 of the striking tools run upwards and inwards, so that the impacting lumps or their components are preferably thrown upwards. This considerably increases the length of time that a lump spends in the rotor chamber 11, thus raising the overall probability that it will be crushed by a striking tool.

In order to avoid or remove caking and encrustations on the inner chamber wall 31, mechanical knocking tools 36 are mounted on the exterior 35 of the chamber wall 29. These cause the chamber wall 29 to vibrate so that any existing caking is released from the inner chamber wall 31. The inner wall 31 thus remains clean so that the desired rebound direction and rebound speed of the impacting lumps is maintained and not hindered by the encrustations. So that the vibration applied does not extend to the rotor shaft 12 and its shaft sections 32, 33 and particularly not to the bearings of the cantilevered shaft, the rotor chamber 11 is mounted on elastic vibration absorbers 44 on the machine frame. In this way the rotor chamber 11 is disconnected from the rotor shaft 12. The knocking tools work during operation so that the released encrustations are immediately crushed again by the striking tools. Due to the downward conical shaping of the rotor chamber, the encrustations which have been loosened and released from the inner chamber wall 31 in the form of slabs land directly in the sphere of operation of the rotating striking tools 20, 21, 22, 23, without the possibility of these sliding down the inner chamber wall 31 without being crushed.

Overall this can result in good or very good separation of slag lumps. At the discharge point there is only a mix of non-metallic and metallic parts which can be properly sorted using conventional methods.

Furthermore on the rotor shaft 12 there is a cover 37 positioned above the uppermost plane 16 of the striking tools, which extends radially from the shaft over the linkages 24, 25 of the striking tools. In this way the linkages 24, 25 are protected from falling lumps. In particular it means that after entering the rotor chamber 11 the lumps land directly in the capture range also of the upper striking tools 20.

The slag lumps are accelerated and crushed by the striking tools and rebound off the inner wall 31 of the rotor chamber 11. From there they land back in the rotor zone. In order to avoid damage to the shaft from rebounding slag lumps, deflector plates 38 are mounted between the linkages 24, 25 of the striking tools at least in the lower planes 17, 18, 19. Due to the gradient of the rotor walls the slag lumps rebounding from the inner wall 31 also have a downward speed component. The deflector plates 38 prevent the rebounding lumps from reaching the shaft so that the service life thereof is considerably increased. The deflector plates 38 extend in radial direction up to at least the outer linkage area 24, 25 of a striking tool 20, 21, 22, 23.

As can be seen particularly in FIG. 5, the striking tools not shown in this drawing of a plane 16, 17, 18, 19 are positioned axis symmetrically on the flanges 26, 27. The embodiment shown in the drawing has four striking tools positioned on the allocated flanges in one plane. Between each of the striking tools there is a deflector plate 38. For this the matching flanges 26, 27 have twelve evenly spaced drill holes around their perimeter. A pin 28 is fixed in every third drill hole 39 to hold a striking tool. Between each striking tool of a plane there are therefore two free drill holes on which the ring-shaped deflector plates are held with their inner rim. In this way the shaft is well protected from the impacting slag lumps. The arrangement of the striking tools 20, 21, 22, 23 of the individual planes 16, 17, 18, 19 can be staggered in the direction of rotation.

The striking tools 20, 21, 22, 23 are paddle-shaped in the top view. The striking tools 20, 21, 22, 23 utilised are wider compared to conventional striking tools. The width of conventional striking tools is indicated in FIG. 3 by the line 43. This considerably increases the service life of the striking tools 20, 21, 22, 23, as wear occurs particularly on the front edges 30, 34 on which the slag lumps are mainly shattered.

1. A device for separating conglomerates that consist of materials of different densities, having a rotor chamber (11), in which a rotor shaft (12) is mounted so as to be rotatable about a vertical axis (40), on which rotor shaft (12) striking tools (20, 21, 22, 23) are arranged one beneath another in at least two planes (16, 17, 18, 19), which striking tools (20, 21, 22, 23) are set into rotational movement by the rotor shaft (12) such that the conglomerates filled into the rotor chamber (11) from above are captured and separated by the striking tools (20, 21, 22, 23), wherein the rotor chamber (11) widens conically downward, and that the outer radius of the striking tools (20, 21, 22, 23) increases from top to bottom such that the spacing (a) of the radially outer end edges (30) of the striking tools (20, 21, 22, 23) from the chamber wall (31) facing said striking tools (20, 21, 22, 23) is substantially the same in the individual planes during operation.

2. The device according to claim 1, wherein the striking tools (20, 21, 22, 23) are mounted flexibly on the rotor shaft (12) and as a result of the rotation pivot into a horizontal operating position.

3. The device according to claim 2, wherein the striking tools (20, 21, 22, 23) of a plane (16, 17, 18, 19) are arranged in axial symmetry to the rotation axis (40).

4. The device according to claim 3, wherein a cover (37) is arranged above the uppermost plane (16), which cover extends in radial direction at least partly over the linkage (24, 25) of the striking tools (20, 21, 22, 23) on the rotor shaft.

5. The device according to claim 4, wherein between the striking tools (20, 21, 22, 23) in one plane there are deflector plates (38), which are fixed to the rotor shaft (12) and extend radially from the rotor shaft.

6. The device according to claim 5, wherein the striking tools (20, 21, 22, 23) in a plane are fixed to at least one flange (26, 27) and that the deflector plates (38) are shaped a part of a ring and are attached to the flange (26, 27) with their inner rim area.

7. The device according to claim 6, wherein the radial outer edge of the deflector plates (38) extends over the linkages (24, 25) of the striking tools (20, 21, 22, 23) on the rotor shaft (12).

8. The device according to claim 1, wherein at least the upper section (32) of the rotor shaft is designed as a hollow shaft, on which at least one upper plane (16, 17) with striking tools (20, 21) is arranged and which is run through by at least one concentrically running shaft (33) and on which at least one lower plane (18, 19) with striking tools (22, 23) is arranged.

9. The device according to claim 8, wherein the striking tools (22, 23) in a lower plane (18, 19) are driven with a different and in particular higher rotational speed in the same or opposite direction as those in an upper plane (16, 17).

10. The device according to claim 9, wherein the rotational speed of the striking tools (20, 21) in an upper plane (16, 17) is 500 rpm up to 1200 rpm.

11. The device according to claim 9, wherein the rotational speed of the striking tools (22, 23) in a lower plane (18,19) is 600 rpm up to 1300 rpm.

12. The device according to claim 1, wherein the cone angle applied from the chamber wall (29) is 20° up to 50° and in particular 24° up to 30°.

13. The device according to claim 1, wherein in the operating position the front edges (30, 34) of the striking tools (20, 21, 22, 23) run upwards and inwards at an angle of 2° up to 15° to the vertical.

14. The device according to claim 1, wherein on the outside (35) of the chamber wall (29) at least one knocking tool (36) is arranged.

15. The device according to claim 1, wherein the rotor chamber (11) is flexibly mounted on elastic vibration absorbers (44).

16. The device according to claim 1, wherein the striking tools (20, 21, 22, 23) of a plane (16, 17, 18, 19) are arranged in axial symmetry to the rotation axis (40).

17. The device according to claim 1, wherein a cover (37) is arranged above the uppermost plane (16), which cover extends in radial direction at least partly over the linkage (24, 25) of the striking tools (20, 21, 22, 23) on the rotor shaft.

18. The device according to claim 1, wherein between the striking tools (20, 21, 22, 23) in one plane there are deflector plates (38), which are fixed to the rotor shaft (12) and extend radially from the rotor shaft.

19. The device according to claim 18, wherein the striking tools (20, 21, 22, 23) in a plane are fixed to at least one flange (26, 27) and that the deflector plates (38) are shaped a part of a ring and are attached to the flange (26, 27) with their inner rim area.

20. The device according to claim 18, wherein the radial outer edge of the deflector plates (38) extends over the linkages (24, 25) of the striking tools (20, 21, 22, 23) on the rotor shaft (12).
